(19) United States
(12) Patent Application Publication
(10) Pub. No.: US 2010/0187197 A1
(43) Pub. Date: Jul. 29, 2010

(54) METHOD FOR MANUFACTURING A VERTICAL MAGNETIC RECORDING MEDIUM

(75) Inventor: Tadashi Yamamoto, Tsukuba-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: ULVAC, Inc., Chigasaki-shi (JP)

(21) Appl. No.: 12/669,214

(22) PCT Filed: Jul. 17, 2008
(86) PCT No.: PCT/JP2008/062904

§ 371 Date: Jan. 15, 2010

(30) Foreign Application Priority Data
Jul. 18, 2007 (JP) 2007-187253

(51) Int. Cl. G11B 5/84

(52) U.S. Cl. 216/22

(57) ABSTRACT

A method for manufacturing a vertical magnetic recording medium that has: a substrate; a soft magnetic layer formed on the substrate; a magnetic recording layer formed directly on the soft magnetic layer or formed on the soft magnetic layer with an intermediate layer therebetween, and having an axis of easy magnetization perpendicular to a surface thereof, in which a plurality of grooves dividing the magnetic recording layer into a plurality of recording elements, the method including a step of forming the grooves by reactive ion etching using a gas containing at least halogen and oxygen, and using the hard mask layer as a mask.

### TECHNICAL FIELD

The present invention relates to a method for manufacturing a vertical magnetic recording medium.

Priority is claimed on Japanese Patent Application No. 2007-187253, filed Jul. 18, 2007, the contents of which are incorporated herein by reference.

### BACKGROUND ART OF THE INVENTION

Conventionally, an areal recording density of a magnetic recording media has been significantly improved by reducing the size of magnetic particles that constitute a magnetic recording layer, changing constituent materials of the magnetic particles, refinement in processing a head, and the like. However, problems such as erroneous recording to a track adjacent to a target track to be recorded and cross talk during playing becomes actualized due to process limitation in manufacturing a magnetic head and broadening of magnetic field during recording by a magnetic head. Consequently, such conventional technology has come to its limits for further improving the areal recording density.

A magnetic recording medium is known in which grooves are formed at boundaries between the mutually adjacent tracks and thus the mutually adjacent tracks are magnetically divided in order to further improve the areal recording density (see, for example, Patent Document 1). Such a magnetic recording medium is referred to as a discrete-track type magnetic recording medium, in which problems such as erroneous recording to a track adjacent to a target track to be recorded or cross talk does not occur since mutually adjacent tracks are physically divided by a groove. Therefore, it is expected that further improvement of the areal recording density can be achieved in such a magnetic recording medium.

As a method for manufacturing such a magnetic recording medium having grooves in its magnetic recording layer, a manufacturing method in which primary grooves are formed on a non magnetic substrate and then a soft magnetic layer or a magnetic recording layer is laminated thereon resulting in forming grooves on the magnetic recording layer along the primary grooves formed on the substrate (see, for example, Patent Document 2).

Further, a method for forming grooves on the magnetic recording layer in which magnetic material of the magnetic recording layer formed on a substrate is carbonylated by chemical etching method so that part of the magnetic material is removed (see, for example, Non Patent Document 1).
[Patent Document 1] Japanese Unexamined Patent Application, First Publication No. 2006-31756
[Patent Document 2] Japanese Unexamined Patent Application, First Publication No. 2006-127681
[Non Patent Document 1] Journal of the Magnetics Society of Japan, Vol. 28, No 3, 2004, P. 249-253

### DISCLOSURE OF THE INVENTION

### Problems to be Solved by the Invention

However, in manufacturing a magnetic recording medium having grooves on a magnetic recording layer, it is difficult to form grooves along primary grooves formed on a substrate by the aforementioned manufacturing method described in Patent Document 2. In fact, there are problems in that, since the crystal orientation of the magnetic recording layer tends to deteriorate, the axis of easy magnetization is not formed in a predetermined direction or adjacent tracks are not completely magnetically divided due to magnetic anisotropy caused at the groove.

In the meantime, in the manufacturing method described in Non Patent Document 1, since a material constituting a magnetic recording layer must be reactive with a carbonyl group used in chemical etching and form a carbonylated compound, another material that has superior magnetic characteristics but is not reactive with a carbonyl group cannot be employed to form grooves.

The present invention was made to solve the above-described problems and has an object of providing a method for manufacturing a vertical magnetic recording medium, in which a material constituting a magnetic recording layer is not limited to a specific type and grooves magnetically dividing the magnetic recording layer into recoding elements can be formed with a high degree of precision.

### Means for Solving the Problem

In order to solve the above-described problems, the present invention employs the following.

In particular, a method for manufacturing a vertical magnetic recording medium according to the present invention has: a substrate; a soft magnetic layer formed on the substrate; a magnetic recording layer formed directly on the soft magnetic layer or formed on the soft magnetic layer with an intermediate layer therebetween, and having an axis of easy magnetization perpendicular to a surface thereof, in which a plurality of grooves dividing the magnetic recording layer into a plurality of recording elements, the method including a step of forming the grooves by reactive ion etching using a gas containing at least halogen and oxygen, and using the hard mask layer as a mask.

It is preferable that the grooves be formed so as to reach the intermediate layer but so as not to expose the soft magnetic layer.

Moreover, it is preferable that the grooves be formed so as to reach the vicinity of a face of the soft magnetic layer while removing impurities attaching on a side wall of the grooves utilizing the difference in etching rate between the soft magnetic layer and the magnetic recording layer.

It is preferable that a gas plasma using a gas containing at least hydrogen be exposed to the magnetic recording layer after forming the grooves.

It may be arranged such that the magnetic recording layer contains at least a Co. It may be arranged such that the magnetic recording layer contains a metallic element which is at least not reactive with a carbonyl group. It may be arranged such that the hard mask layer contains at least any one of Ti, W, and Ta.

It may be arranged such that the grooves are formed along a recording track direction of the vertical magnetic recording medium.

Moreover, it may be arranged such that the grooves are formed along a recording track direction of the vertical magnetic recording medium as well as a direction perpendicular to the recording track direction.

Further, it may be arranged such that the grooves are formed in substantially a lattice pattern.

### ADVANTAGEOUS EFFECTS OF THE INVENTION

Based on the method for manufacturing a vertical magnetic recording medium according to the present invention, it is possible to form highly precise and fine grooves on the magnetic recording layer by etching the magnetic recording layer using an etching gas containing oxygen and halogen.

In addition, it is possible to perform etching to a magnetic recording layer composed of a material containing a metallic element such as Pt or Cr, that is not reactive with a carbonyl group and thus cannot be etched by a conventional etching based on carbonylation. Accordingly, it is possible to form highly precise grooves on the magnetic recording layer composed of a material containing a metallic element such as Pt or Cr that is not reactive with a carbonyl group.

In addition, since the magnetic recording layer is etched using the etching gas containing oxygen and halogen, an oxide film is formed on the surface of the hard mask layer, and thus the difference in the etching rate between the hard mask layer and the magnetic recording layer becomes considerably large. Accordingly, if the thickness of the hard mask layer is considerably small relative to the depth of grooves to be formed on the magnetic recording layer, the grooves can be formed on the magnetic recording layer so as to have a predetermined depth. By reducing the thickness of the hard mask layer, particles shot off from the hard mask layer due to etching process can be prevented from attaching to the groove. Accordingly, it is possible to form the grooves with a high degree of accuracy and to remove the remaining hard mask layer in the following step.

### BRIEF DESCRIPTION OF THE DRAWINGS

FIG. 1A is a cross sectional view showing an example of a vertical magnetic recording medium formed by a method for manufacturing a vertical magnetic recording medium according to the present invention.

FIG. 1B is an enlarged view showing “a” in FIG. 1A.

FIG. 2A is a cross sectional view showing an example of a method for manufacturing a vertical magnetic recording medium according to the present invention.

FIG. 2B is a cross sectional view showing an example of a method for manufacturing a vertical magnetic recording medium according to the present invention.

FIG. 2C is a cross sectional view showing an example of a method for manufacturing a vertical magnetic recording medium according to the present invention.

FIG. 2D is a cross sectional view showing an example of a method for manufacturing a vertical magnetic recording medium according to the present invention.

FIG. 3A is a cross sectional view showing an example of a method for manufacturing a vertical magnetic recording medium according to the present invention.

FIG. 3B is a cross sectional view showing an example of a method for manufacturing a vertical magnetic recording medium according to the present invention.

FIG. 3C is a cross sectional view showing an example of a method for manufacturing a vertical magnetic recording medium according to the present invention.

FIG. 3D is a cross sectional view showing an example of a method for manufacturing a vertical magnetic recording medium according to the present invention.

FIG. 4 is a cross sectional view showing another example of the vertical magnetic recording medium.

FIG. 5 is a cross sectional view showing another example of the vertical magnetic recording medium.

FIG. 6 is a graph showing verification result of the present invention.

### DESCRIPTION OF THE REFERENCE SYMBOLS

10 Vertical magnetic recording medium
11 Substrate
12 Soft magnetic layer
13 Intermediate layer
14 Magnetic recording layer
15 Groove

### BEST MODE FOR CARRYING OUT THE INVENTION

Hereinafter, a preferable embodiment of a method for manufacturing a vertical magnetic recording medium according to the present invention will be described. It should be noted that a detailed explanation in the present embodiment is given solely to facilitate better understanding of the spirit and scope of the invention, and is not to be considered limitative of the invention unless otherwise specified.

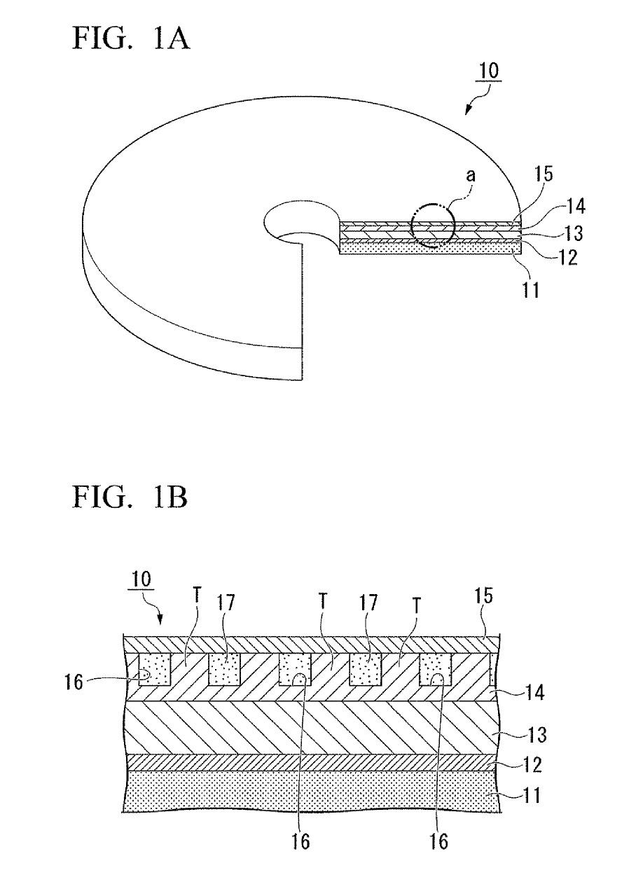

First, an example of a vertical magnetic recording medium manufactured by a method according to the present invention is explained. FIG. 1A and FIG. 1B are a partly exploded perspective view and principal part enlarged view, respectively, showing a discrete-track type vertical magnetic recording medium used in a hard disk drive of a computer. It is noted that the scale of the components are enlarged particularly in the thickness direction such that the components are drawn in a recognizable dimension.

A vertical magnetic recording medium 10 has a structure in which a soft magnetic layer 12, an intermediate layer 13, a magnetic recording layer 14 and a protective layer 15 are laminated on a substrate 11 in this order.

### <Substrate>

As the substrate 11, for example, a base substrate consisting of aluminum and its alloys or oxides, titanium and its alloys or oxides, or silicon, glass, carbon, ceramic, plastic, resin and their compounds, of which the surface is coated with a nonmagnetic layer of heterogeneous materials by a film forming method such as sputtering, deposition, and metal plating may be employed.

The shape of the substrate 11 used for disks is that of a discoidal doughnut. The substrate 11 on which a magnetic recording layer 14 described below is formed, that is, the vertical magnetic recording medium 10 is rotated, for example, at a speed of 3,600 rpm to 15,000 rpm around the center axis of the disk at the time of recording and playing. At this time, a magnetic head, that performs reading and writing, runs above the surface or back surface of the magnetic recording medium while being spaced apart therefrom by approximately 0.1 μm to several nm. Therefore, it is preferable that the substrate 11 be made in such a way that the flatness of the surface and back surface, the parallelism between the surface and back surface, the circumferential waviness of the substrate and the roughness of both the surface and back surface are properly controlled.

### <Soft Magnetic Layer>

The soft magnetic layer 12 constituting the upper layer of the substrate 11 can be formed by sputtering, deposition, or the like. For example, an amorphous alloy film such as CoNbZr film, a microcrystal precipitation alloy film such as a FeTaC film, or a crystalline alloy film such as a NiFe film may be employed as the soft magnetic layer 12. Alternatively, the soft magnetic layer 12 may be a multilayered film including soft magnetic layers and non-magnetic layers alternately laminated one another, for example.

### <Intermediate Layer>

The intermediate layer 13 is also referred to as an alignment layer. An example of the intermediate layer 13 aligns the axis of easy magnetization of the magnetic recording layer 14 laminated on the intermediate layer 13 perpendicular to the surface of the vertical magnetic recording medium 10. Alternatively, the intermediate layer 13 helps enhancing the epitaxial growth of the magnetic recording layer 14. It is preferable that the intermediate layer 13 be formed from an approximately 0.1 to 10 nm-thick metallic film having a face centered cubic structure (fcc) or a hexagonal closest packed structure (hcp). In particular, it is preferable to employ a CoCr alloy, a CoCrRu alloy, Pd, Cu, Pt, Ru, or the like.

### <Magnetic Recording Layer>

The magnetic recording layer 14 may be made from a ferromagnetic material of which the axis of easy magnetization aligns perpendicular to the surface of the vertical magnetic recording medium 10, for example. It is noted that the alignment of the axis of easy magnetization of the magnetic recording layer 14 may be controlled therein by itself or controlled by the intermediate layer 13. The composition of the magnetic recording layer 14 is not limited to a specific material but it is preferable to use a CoCr based ferromagnetic film having a hexagonal closest packed structure (hcp) of which the axis of easy magnetization is substantially perpendicular to the surface thereof. It may be arranged such that another element is added to the CoCr based ferromagnetic material if necessary.

As such a CoCr based ferromagnetic material, CoCr based alloys such as CoCr, CoCrNi, CoCrTa, CoCrPt, CoCrPtTa and CoCrPtB may be employed, for example. It is preferable that the ferromagnetic material contain an additive such as O, SiOx, Fe, Mo, V, Si, B, Ir, W, Hf, Nb, Ru, rare earth elements, or the like, in order to deal with issues such as size control of the crystal grains, segregation control between the grains, control of the crystal magnetic anisotropy constant Ku_{grain} of the crystal grains, control of the corrosion resistance, adaptability for low-temperature process.

In place of the above-mentioned CoCr based alloys, a ferromagnetic material that has superior thermal agitation resistance such as CoPt, CoPd, or FePt may be employed. In addition, the ferromagnetic material may contain B, N, O, SiOx, Zr, or the like in order to miniaturize the ferromagnetic material.

Further, a magnetic recording layer having a multilayered structure in which a plurality of Co layers and Pt layers are alternatively laminated may be employed. Besides the above-described multilayered structure, a multilayered structure composed of a combination of Co layers and Pd layers, a combination of Fe layers and Pd layers, or the like may be employed for the magnetic recording layer. In addition, those layers may contain an additive such as B, N, O, Zr, SiOx. It is also preferable to employ CoPtCr—SiO₂ granular grains.

A plurality of grooves 16 is formed on the magnetic recording layer 14. The grooves 16 magnetically divide the magnetic recording layer 14 into a plurality of recording elements. A plurality of tracks T being the recording elements is formed on the magnetic recording layer 14 due to the presence of the grooves 16. Since mutually adjacent tracks T (recording element) are completely magnetically divided by the grooves 16, erroneous recoding to a track adjacent to a target track to be recorded or cross talk does not occur. As a result, it is possible to significantly improve the areal recording density. The detail of the method for forming the grooves 16 will be described later.

The grooves 16 are filled with a non-magnetic material layer 17 such as SiO₂ or a resin. Accordingly, it is possible to reliably perform the magnetic separation between mutual adjacent tracks T as well as to planarize the top surface of the recording layer 14.

### <Protective Layer>

The protective layer 15 covering the magnetic recording layer 14 on which the grooves 16 are formed may be formed from a hard carbon film, which is referred to as a diamond like carbon, having a thickness of approximately 1 to 5 nm. The protective layer 15 prevents the magnetic recording layer 14 from being damaged as well as keeps the surface of the vertical magnetic recording medium 10 flat. It is noted that a structure for promoting a smooth contact with a magnetic head of a hard disk drive such as a lubricant layer made of a fluorine-based lubricating agent may additionally be formed on top of the protective layer 15.

It should be noted that the multilayered structure of the vertical magnetic recording medium 10 shown in FIG. 1A and FIG. 1B is an example of a basic structure of a discrete type magnetic recording medium and thus the present invention is not limited to the multilayered structure of the vertical magnetic recording medium 10. Alternatively, a structure in which another intermediate layer is additionally provided as necessary between the substrate 11 and magnetic recording layer 14 may be employed.

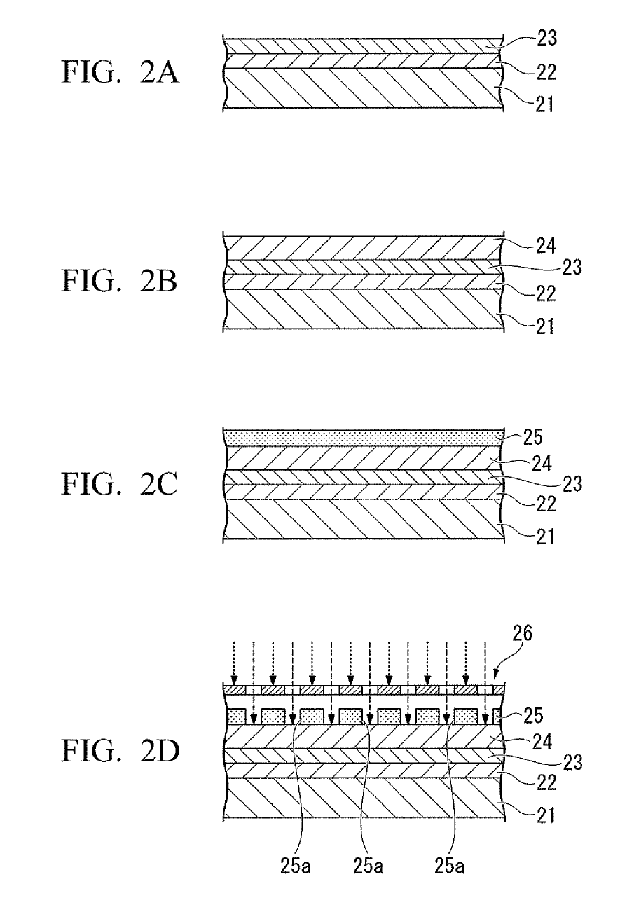

Hereinunder is an explanation on a method for manufacturing a vertical magnetic recording medium according to the present invention, in particular, a step of forming grooves on the magnetic recording layer. FIG. 2A to FIG. 2D is a schematic view showing the manufacturing method of a vertical magnetic recording medium in a stepwise fashion. First, as shown in FIG. 2A, a soft magnetic layer 22 and intermediate layer 23 are laminated on a non magnetic substrate 21 in this order. Then, a magnetic recording layer 24 is laminated on the intermediate layer 23 as shown in FIG. 2B. The axis of easy magnetization in the magnetic recording layer 24 is formed by itself or by the action of the intermediate layer 23, so as to be perpendicular to the surface of the magnetic recording layer 24.

The soft magnetic layer 22, the intermediate layer 23, and the magnetic recording layer 24 may be formed of the materials illustrated in the above detail descriptions for the vertical magnetic recording medium explained with reference to FIG. 1A and FIG. 1B. In addition, the soft magnetic layer 22, the intermediate layer 23, and the magnetic recording layer 24 may be composed from a plurality of layers.

Next, a hard mask layer 25 is formed on the magnetic recording layer 24 as shown in FIG. 2C. The hard mask layer 25 is used for forming grooves on the magnetic recording layer 24 in the following step. The hard mask layer 25 may be formed of Ti, W, Ta, their oxides or nitrides, or the like. In particular, it is preferable that the hard mask layer 25 be formed of a material which forms its oxide with oxygen and thus have an etching resistance against gases containing halogen.

The hard mask layer 25 may be formed to have a thickness, for example, of approximately 2 to 20 nm. As a method for laminating the hard mask layer 25, sputtering, deposition, or the like may be employed.

Next, a hole pattern 25a is formed in the hard mask layer 25 as shown in FIG. 2D. The hole pattern 25a is formed so as to be along grooves to be formed on the magnetic recording layer 24 in the following step. As a method for forming the hole pattern 25a, dry etching can be employed in which a resist mask is used to etch the hard mask layer 25. Alternatively, nanoimprint lithography, a method of exposing an electron beam onto a preliminarily resist layer, or a method in which KrF or ArF excimer laser is exposed may be employed to form the resist mask having a pattern. In accordance with a type of resist, UV curing or heat treatment may be performed.

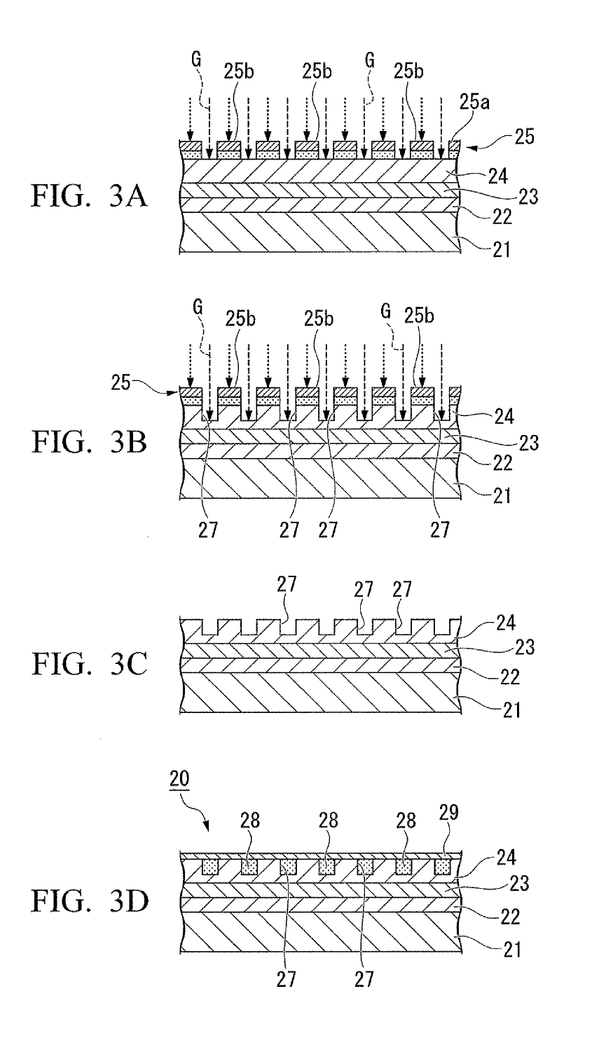

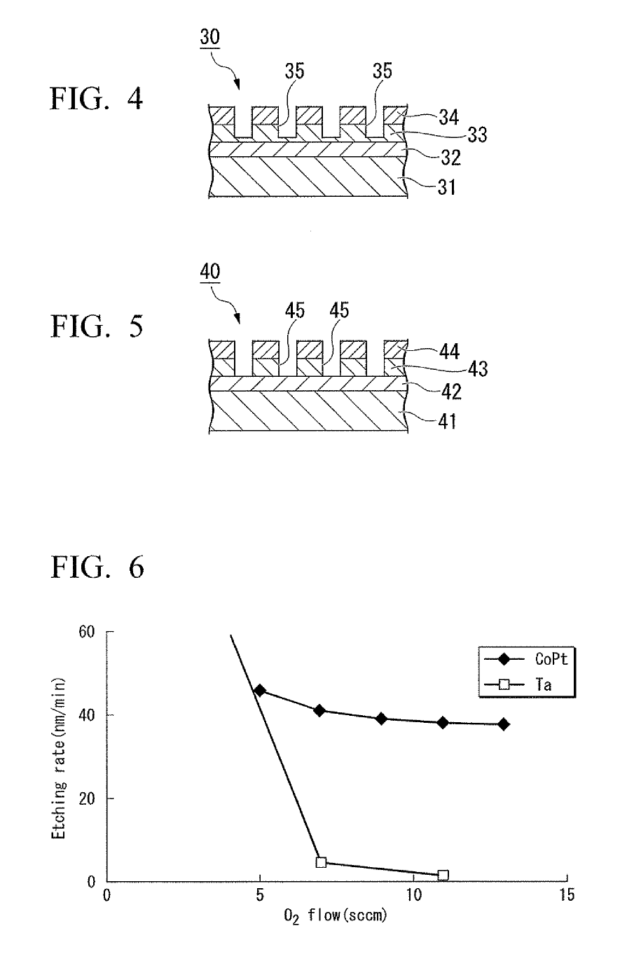

Then, grooves are formed on the magnetic recording layer 24 using the hard mask layer 25 on which the hole pattern 25a as a mask as shown in FIG. 3A. In forming the grooves on the recording layer 24, a reactive etching is performed using etching gas G in which a gas containing halogen such as fluorine or chlorine and a gas containing a certain amount of oxygen are mixed together.

For the gas containing halogen, Cl₂, BCl₃, HBr, or the like can be preferably used. Meanwhile, in place of the gas containing oxygen, CO, CH₃OH, C₂H₅OH, or the like may be used. In addition, these gases may contain N₂ or an inert gas such as Ar, Xe, or Kr as a dilution gas. The ratio of oxygen in the etching gas G is preferably 10 to 25%, for example. An example of a preferable condition for the reactive etching is that the gas pressure is approximately 0.1 Pa to 3.0 Pa, heating temperature is approximately from room temperature to 300° C., the antenna (source) power for plasma is approximately 300 to 2000 W, and the substrate bias power is approximately 50 to 1000 W.

After performing the reactive etching using the etching gas G containing oxygen and halogen as mentioned above, exposed portions of the magnetic recording layer 24 through the hole pattern 25a of the hard mask layer 25 are etched by the etching gas G, and hence grooves 27 are formed which is aligned along the hole pattern 25a of the hard mask layer 25, as shown in FIG. 3B.

In addition, after performing the reactive etching using the etching gas G containing oxygen and halogen as mentioned above, an oxide film 25b is formed on the surface of the hard mask layer 25, as shown in FIG. 3B. The oxide film 25b is formed of oxidized Ti, Ta, or the like that originally constitute the hard mask layer 25.

After the oxide film 25b is formed on the hard mask layer 25, the difference in the etching rate for the etching gas G between the hard mask layer 25 and the exposed portions of the magnetic recording layer 24 through the hole pattern 25a of the hard mask layer 25 becomes considerably large. To be specific, the etching rate of the hard mask layer 25 on which oxide film 25b is formed becomes considerably smaller than that of the magnetic recording layer 24. This is because the oxide film 25b is hard to react with halogen in the etching gas G.

Accordingly, if the thickness of the hard mask layer 25 is considerably small relative to the depth of grooves 27 to be formed on the magnetic recording layer 24, the grooves 27 can be formed on the magnetic recording layer 24 so as to have a predetermined depth. In this case, since the thickness of the hard mask layer 25 can be thinner, it becomes easy to remove the hard mask layer 25 in the following step.

In addition, by using a gas containing halogen as the etching gas G in the etching step, it is possible to perform etching to the magnetic recording layer 24 composed of a material containing Pt or Cr, that is not reactive with a carbonyl group, and thus cannot be etched by a conventional etching based on carbonylation. This is because Pt or Cr does not react with a carbonyl group but does react with halogen to form compounds such as PtCl₃, PtCl₄, PtBr₂, PtI₄, and CrCl₂. Accordingly, it is possible to form the grooves 27 with a high degree of precision on the magnetic recording layer 24 composed of a material containing Pt or Cr.

In addition, it is preferable that the ratio of the etching rate of the magnetic recording layer 24 to that of the hard mask layer 25 range from 5.0 to 20.0. In order to make the ratio of the etching rate be within this range, the etching gas G containing, for example, Cl₂ gas (60%), O₂ gas (15%), and Ar gas (25%) is used with the magnetic recording layer 24 composed of CoCrPt and the hard mask layer 25 composed of Ta.

After the grooves 27 having a predetermined depth and pattern is formed on the magnetic recording layer 24, the hard mask layer 25 is removed (see FIG. 3C). In removing the hard mask layer 25, gas plasma is generated using gas species X containing fluorine, halogen, or the like, and then the hard mask layer 25 is removed by the gas plasma, for example. In this case, since the above-mentioned gas species X does not contain oxygen, an etching rate of the constituent of the hard mask such as W, Ti, Ta, or their oxide is high. Thus, the hard mask layer 25 is etched much slower than the magnetic layer at the grooves 27. In addition, plasma treatment using a gas containing hydrogen, rinsing with pure water, rinsing with organic solvent, or the like may additionally be performed after the etching step in order to prevent the protective layer that is to be finally exposed, the magnetic layer, or the intermediate layer from corrosion.

After the grooves 27 are formed on the magnetic recording layer 24 through the above-described steps, the grooves 27 are filled with a non magnetic material layer 28 that is composed of SiO₂, resin, or the like to planarize the top surface of the magnetic recording layer 24 as shown in FIG. 3D. Further, a protective layer 29 for preventing the magnetic recording layer 24 from being damaged and lubricating the surface is formed on the magnetic recording layer 24, thereby completing the vertical magnetic recording medium 20.

It is noted that the grooves formed on the magnetic recording layer may be formed so as to reach into the intermediate layer or formed so as to reach into the magnetic recording layer in which the depth of the grooves is less than the thickness of the magnetic recording layer as described above. As an example, a vertical magnetic recording medium 30 is shown in FIG. 4 in which a soft magnetic layer 32, an intermediate layer 33, and a magnetic recording layer 34 are laminated on the surface of the substrate 31 in this order; and grooves 35 dividing the magnetic recording layer 34 into a plurality of recording elements (tracks) penetrate the magnetic recording layer 34 and reach into the intermediate layer 33.

By performing hydrogen gas plasma treatment to the grooves 35 formed as described above, the soft magnetic layer 32 can be prevented from corrosion. The gas containing hydrogen for generating the gas plasma may be interchangeable with a compound containing hydrogen (e.g., water vapor) or a mixed gas containing hydrogen and another gas (e.g., hydrogen gas with argon, nitrogen, oxygen, xenon, or the like). By exposing gas plasma generated from such a gas containing hydrogen, it is possible to perform anticorrosion treatment to the magnetic recording layer 24 as well as to reliably remove the hard mask layer 25 on the magnetic recording layer 24, and further to remove residual etching gas that has been used for forming the grooves 27.

As has been explained above, by forming the grooves 35 so as to reach into the intermediate layer 33, mutually adjacent recording elements of the magnetic recording layer 34 are reliably magnetically divided. Thus, if such a structure is employed in a magnetic recording medium of a hard disk drive, it becomes possible to reliably prevent problems such as erroneous recoding to an adjacent layer and cross talk. Further, the grooves 35 can be protected from corrosion and deterioration by exposing gas plasma generated from a gas containing hydrogen.

In the meantime, as an another example, a vertical magnetic recording medium 40 is shown in FIG. 5 in which a soft magnetic layer 42, an intermediate layer 43, and a magnetic recording layer 44 are laminated on the surface of the substrate 41 in this order; and grooves 45 penetrate the magnetic recording layer 44 and the intermediate layer 43 to expose the soft magnetic layer 42.

The grooves 45 are formed so as to reach the vicinity of the face of the soft magnetic layer 42 due to the difference in the etching rate between the soft magnetic layer 42 and the magnetic recording layer 44 while removing impurities attaching on the side wall of the grooves 45. Accordingly, impurities reattaching to the magnetic recording layer 44 can be reliably removed.

As described above, by forming the grooves 45 so as to reach the vicinity of the face of the soft magnetic layer 42, mutually adjacent recording elements of the magnetic recording layer 44 are reliably magnetically divided. Thus, if the vertical magnetic recording medium 40 is employed in a magnetic recording medium of a hard disk drive, it becomes possible to reliably prevent problems such as erroneous recoding to an adjacent layer and cross talk.

### Example

In order to verify the advantageous effect of the present invention, the difference in etching rate between the hard mask layer and the magnetic recording layer was examined. In the examination, a magnetic recording layer having a thickness of 150 nm and composed of CoPt was formed on a substrate mainly composed of glass. In the meantime, a hard mask layer having a thickness of 150 nm and composed of Ta was formed on the substrate described above. Etching was performed on each single-layer film under various etching conditions, and cross sections of the etched films were observed by SEM to calculate an etching rate for each film.

In the above etching, etching gas, which contains a mixture of Cl₂ gas with a flow rate of 40 sccm and Ar gas with a flow rate of 20 sccm to which O₂ gas was added in a stepwise fashion, was used. The etching condition was that the gas pressure was 0.5 Pa, plasma source power was 600 W, and substrate bias power was 300 W. In FIG. 6, etching rate variations of the hard mask layer (Ta) and the magnetic recording layer (CoPt) when increasing, in a stepwise fashion, the amount of O₂ contained in the etching gas is shown.

According to FIG. 6, it is understood that the etching rate of hard mask layer (Ta) is significantly lowered compared to that of magnetic recording layer (CoPt) when increasing the amount of oxygen contained in the etching gas. From this result, it is confirmed that if the thickness of the hard mask layer (Ta) used as a mask when forming grooves on the magnetic recording layer is considerably small relative to that of the magnetic recording layer (CoPt), the grooves can be formed on the magnetic recording layer so as to have a sufficient depth.

In the above-described embodiment, an example in which a method for manufacturing a vertical magnetic recording medium according to the present invention is applied to manufacturing a discrete track type magnetic recording medium has been illustrated, but the application is not limited to this. The method for manufacturing a vertical magnetic recording medium according to the present invention can be applied to manufacturing a so-called patterned media. In the discrete track type magnetic recording medium described above, the magnetic recording layer is divided in one direction (track direction). On the other hand, in the patterned media, the magnetic recording layer is two-dimensionally divided in the track direction as well as a direction perpendicular to the track direction into single magnetic domains.

In applying the manufacturing method of a vertical magnetic recording medium according to the present invention to manufacturing such a patterned media, for example, a hard mask layer having a pattern corresponding to an alignment of single magnetic domains in the patterned media is employed. In this case, grooves corresponding to the pattern of the hard mask layer are formed on the magnetic recording layer. In addition, according to the above-described embodiment, it is possible to form grooves corresponding to various types of alignment patterns of single magnetic domains. A typical example is grooves formed in substantially a lattice pattern.

By filling such grooves formed as described above with a non magnetic as shown in the above-described embodiment, a patterned media is obtained.

### INDUSTRIAL APPLICABILITY

It is possible to provide a method for manufacturing a vertical magnetic recording medium, in which a material constituting a magnetic recording layer is not limited to a specific type and grooves magnetically dividing the magnetic recording layer into recoding elements can be formed with a high degree of precision.

What is claimed is:

1. A method for manufacturing a vertical magnetic recording medium that has:
a substrate; a soft magnetic layer formed on the substrate; a magnetic recording layer formed directly on the soft magnetic layer or formed on the soft magnetic layer with an intermediate layer therebetween, and having an axis of easy magnetization perpendicular to a surface thereof, in which a plurality of grooves dividing the magnetic recording layer into a plurality of recording elements, the method comprising a step of forming the grooves by reactive ion etching using a gas containing at least halogen and oxygen, and using the hard mask layer as a mask.

2. The method for manufacturing a vertical magnetic recording medium according to claim 1, wherein the grooves are formed so as to reach the intermediate layer but so as not to expose the soft magnetic layer.

3. The method for manufacturing a vertical magnetic recording medium according to claim 1, wherein the grooves are formed so as to reach the vicinity of a face of the soft magnetic layer while removing impurities attaching on a side wall of the grooves utilizing the difference in etching rate between the soft magnetic layer and the magnetic recording layer.

4. The method for manufacturing a vertical recording medium according to claim 1, wherein a gas plasma using a gas containing at least hydrogen is exposed to the magnetic recording layer after forming the grooves.

5. The method for manufacturing a vertical magnetic recording medium according to claim 1, wherein the magnetic recording layer contains at least a Co.

6. The method for manufacturing a vertical magnetic recording medium according to claim 1, wherein the magnetic recording layer contains a metallic element which is at least not reactive with a carbonyl group.

7. The method for manufacturing a vertical magnetic recording medium according to claim 1, wherein the hard mask layer contains at least any one of Ti, W, and Ta.

8. The method for manufacturing a vertical magnetic recording medium according to claim 1, wherein the grooves are formed along a recording track direction of the vertical magnetic recording medium.

9. The method for manufacturing a vertical magnetic recording medium according to claim 1, wherein the grooves are formed along a recording track direction of the vertical magnetic recording medium as well as a direction perpendicular to the recording track direction.

10. The method for manufacturing a vertical magnetic recording medium according to claim 9, wherein the grooves are formed in substantially a lattice pattern.
